(19) United States
(12) Patent Application Publication
(10) Pub. No.: US 2012/0246376 A1
(43) Pub. Date: Sep. 27, 2012

(54) METHOD FOR OPERATING A FIELDBUS INTERFACE

(75) Inventors: Robert Kolblin, Lorrach (DE); Michael Neval, Schopfheim (DE); Jorg Reinkensmeier, Steinen (DE); Axel Poschmann, Basel (CH)

(73) Assignee: Endress + Hauser Process Solutions AG, Reinach (CH)

(21) Appl. No.: 13/499,329

(22) PCT Filed: Aug. 30, 2010
(86) PCT No.: PCT/EP2010/062611

§ 371 Date: Jun. 8, 2012

(30) Foreign Application Priority Data
Oct. 6, 2009 (JP) 10 2009 045 386.5

(51) Int. Cl. G06F 13/36

(52) U.S. Cl. 710/305

(57) ABSTRACT

A method for operating a fieldbus interface, which is connected to a fieldbus of process automation technology. The method includes the steps as continuous monitoring of data traffic on the fieldbus by the fieldbus interface; need-dependent performing of active communication by the fieldbus interface in parallel with the monitoring of the data traffic; and registering by the fieldbus interface of monitored information concerning network management of the fieldbus.

The present invention relates to a method for operating a fieldbus interface, which is connected to a fieldbus of process automation technology.

In process automation technology, field devices are often used, which serve for registering and/or influencing process variables. Serving for registering process variables are sensors, such as, for example, fill level measuring devices, flow measuring devices, pressure and temperature measuring devices, pH redox potential measuring devices, conductivity measuring devices, etc., which register the corresponding process variables, fill level, flow, pressure, temperature, pH value, and conductivity, respectively. Serving for influencing process variables are actuators, such as, for example, valves or pumps, via which the flow of a liquid in a pipeline section or the fill level in a container can be changed. In principle, all devices, which are applied near to a process and which process or deliver process-relevant information, are referred to as field devices. A large number of such field devices are available from the firm, Endress+Hauser.

In modern industrial plants, field devices are, as a rule, connected via bus systems (Profibus®, Foundation® Fieldbus, HART®, etc.) with superordinated units. Normally these superordinated units are control systems or control units, such as, for example, PLCs (Programmable Logic Controllers). The superordinated units serve, among other things, for process control, process visualizing and process monitoring, as well as for start up of the field devices.

In order to keep the downtimes of a plant, especially a plant of process automation technology, as small as possible and in order to provide the plant operator with as comprehensive as possible information concerning assets installed in the plant, in modern plants, computer supported asset management systems (abbreviated: PAM systems wherein PAM stands for “Plant Asset Management”) are frequently applied. Referred to as “assets” in such case are generally the parts of a plant representing value for the plant, such as, for example, the field devices installed in a plant. As a rule, PAM systems manage information concerning the assets of a plant in a database. In such case, in a PAM system, as a rule, the assets installed in a plant, especially field devices, a replacing of devices, changes to devices, such as, for example, the replacement of sensors, the implementing of a new software version, etc., are registered, and the respective chains of events are documented. A PAM system is especially often designed in such a manner that it regularly performs network verification, in order to ascertain the devices information technically connected to a fieldbus. Furthermore, performed maintenance tasks are, as a rule, documented using a PAM system. In such case, as a rule, also corresponding information for device integration of the various field devices of a plant, especially device descriptions and/or a device drivers for the field devices, are implemented in a PAM system. An example of a PAM system is the FieldCare® product of Endress+Hauser.

PAM systems are, as a rule, guided by the plant operator. They are, in such case, often formed separately from a superordinated unit (e.g. a PLC), which serves for process control, and are connected to a superordinated company network (for example, to an Ethernet® network. In this way, among other things, the registering of the assets of a plurality of fieldbus segments can occur in a shared PAM system.

Problematic, in such case, is that the PAM system should be informed, as near in time as possible, of changes on a fieldbus, especially of a change in the devices information technically connected to the relevant fieldbus. Along with that, also for other superordinated communication units, which, for example, are connected to a network superordinated to the fieldbus, there exists in part the need that these be informed as near in time as possible of such information concerning the network management of the fieldbus. For only thusly can changes in a plant be registered near in time, and, in given cases, errors, or defects, recognized early.

An opportunity exists to connect a master class 2 (short: MC2) as a fieldbus interface to a fieldbus, which is embodied according to the PROFIBUS® standard, and to provide a communication connection (for example, via a superordinated company network) between this and a PAM system (or, in general, a superordinated communication unit). In this way, using acyclic communication, the MC2 can ascertain the information required for the PAM system (or, the superordinated communication unit) concerning the network management of the fieldbus, and can forward this information to the PAM system (or the superordinated communication unit). The MC2 must in such case itself query for all required information, since it has no access to information, which concerns the network management of the fieldbus, and which are regularly queried in the context of the process control from a master class 1 (MC1 for short) connected to the fieldbus.

Only a relatively short time interval between the cycles of the MC1 are available to the MC2 for the communication to be performed, so that due to the high quantity of data to be ascertained via the MC2, a considerable time period is required to query for all required information. In this way, the timeliness of the information provided by the MC2 is negatively affected. Additionally, via the MC2, the data traffic on the fieldbus is significantly increased. A corresponding problem exists, among other things, also in the case of a fieldbus, which is embodied according to the Foundation® Fieldbus standard and in which a corresponding fieldbus interface is provided.

From the publication WO 2007/074105 A2, a method is known for plant monitoring in a plant, in which a number of field devices communicate via a fieldbus with a process control unit and a plant monitoring unit, such as, for example, a gateway. In such case, the plant monitoring unit tests the regular data traffic for information, which indicates a diagnostic event in the case of one of the field devices. If a telegram with an indication of a diagnostic event is detected, other diagnostic information of the relevant field device is requested by the plant monitoring unit.

An object of the present invention is to provide a fieldbus interface for connection to a fieldbus of process automation technology, as well as a method for operating such a fieldbus interface, through which at least information, which concerns the network management of the fieldbus, is registerable in such a way so as to be as current as possible, and is providable, either directly or in conditioned form, to a superordinated communication unit, such as, for example, a PAM system. An unnecessary loading of the bus traffic on the fieldbus via the fieldbus interface should, in such case, be avoided.

The object is achieved by a method for operating a fieldbus interface as such method is defined in claim 1 as well as by a fieldbus interface as defined in claim 15. Advantageous further developments of the invention are set forth in the dependent claims.

According to the present invention, a method is provided for operating a fieldbus interface, which is connected to a fieldbus of process automation technology. The method includes steps as follows:
A) Continuous monitoring of data traffic on the fieldbus by the fieldbus interface;
B) need-dependent performing of active communication by the fieldbus interface in parallel with the monitoring of the data traffic; and
C) registering by the fieldbus interface of monitored information concerning network management of the fieldbus.

Since the fieldbus interface continuously monitors (listener functionality) the data traffic on the fieldbus, it can obtain many pieces of information concerning the network management of the fieldbus without performing an active communication. For example, an MC1 in a fieldbus, which is embodied according to the Profibus® standard, regularly performs, as a rule in the context of the process control, a retrieval of the fieldbus addresses, in order to test which devices are information technically connected at the different fieldbus addresses. Via continual monitoring of the data traffic on the fieldbus, the fieldbus interface can accordingly obtain information concerning at which addresses devices are information technically connected, whether a master or a slave is in such case involved, and, in the case of a slave, it can furthermore determine the association with a particular master (to the extent that a number of master class 1 (MC1) are provided). Along with that, via monitoring, the fieldbus interface can also register other information, as is especially subsequently explained with reference to further developments.

In that the fieldbus interface also performs, as needed, an active communication, it can targetedly retrieve additional information, which it requires from individual devices connected to the fieldbus, especially from field devices. In such case, the fieldbus interface can retrieve information, which would not be obtainable in the context of the process control of a superordinated unit (for example, a PLC, which forms an MC1 in a Profibus® network). In this way, by the fieldbus interface, more information can be provided, near in time, to a superordinated communication unit, such as, for example, a PAM system, than would be possible via a superordinated unit for process control. Via such an active communication, besides information concerning the network management of the fieldbus, also other information (e.g. diagnostic information, etc.) can be queried by the fieldbus interface.

The fieldbus interface can thus, in a comprehensive and up-to-date manner, provide information concerning the network management of the fieldbus, without the bus traffic to the fieldbus being strongly burdened thereby.

Referred to as a “fieldbus interface” herein is a module, which is embodied for a connection to a fieldbus, and via which information, which is communicated over the fieldbus, is at least partially providable to a superordinated communication unit. The superordinated communication unit can, in such case, be connected to the fieldbus interface directly, via a superordinated network (e.g. a firm-internal Ethernet LAN (LAN: Local Area Network)) or via another communication connection (e.g. a USE interface). In given cases, also a protocol conversion is performed by the fieldbus interface, as is also the situation in the case of a gateway.

By a “continuous” monitoring or the performing of an active communication “parallel” to the monitoring of the data traffic, it is in such case meant that the fieldbus interface monitors the data traffic, regardless of whether the fieldbus interface itself (or also other participants to the fieldbus) is actively performing a communication. As a result, a gapless monitoring of (or listening to) all telegrams transmitted over the fieldbus is achieved.

From a technical perspective, this parallel functionality of such a fieldbus interface can be implemented, for example, by branching the mechanical connection of the fieldbus interface, via which the fieldbus interface is connected to the fieldbus, into two “channels”, along which the arriving telegrams are conveyed. The one channel is, in such case, embodied in such a manner that the arriving telegrams all, regardless of whether they are addressed to the fieldbus interface, are passed through, and accordingly, their content can be further processed in the fieldbus interface. In this way, the continuous monitoring functionality is provided. The other channel is, in contrast, embodied in such a manner that the arriving telegrams are only passed through when they are addressed to the fieldbus interface. This channel is, in such case, required especially for performing an active communication (for obtaining the response telegrams for corresponding queries). For example, this other channel can be turned off, when the fieldbus interface is not performing active communication.

An “active” communication means that a corresponding query can be actively made through the fieldbus interface. Such a query can, as is explained subsequently with reference to a further development, be made, for example, in an acyclic communication by the fieldbus interface.

In the case of “monitored information”, reference is made both to information, which is exchanged between other communication participants via the fieldbus, as well as such information, whose telegrams are addressed to the fieldbus interface. In the fieldbus interface, the monitored information is then checked as to whether it involves information, which concerns the network management of the fieldbus, or other information to be registered by the fieldbus interface. Only when information to be registered is involved is this information registered—and especially stored—in the fieldbus interface. In given cases, the registered information is also further processed in the fieldbus interface and is provided in conditioned and/or summarized form to a superordinated communication unit. This is especially subsequently explained based on further developments of the invention.

Information concerning network management comprises at least information concerning at which fieldbus addresses devices are information technically connected. By “information technically connected” is in such case meant, in comparison to a purely mechanical connection, that the relevant device at the relevant address answers a corresponding query directed to this address. Moreover, the information to be registered, which concerns the network management, can also contain one or more of the following types of information:
information concerning whether an information technically connected device is a master or a slave (at least in the case of a Profibus® fieldbus);
information concerning whether more than only one master (at least in the case of a Profibus® fieldbus), especially more than only one MC1, is information technically connected to the fieldbus (detectable if a first MC1 passes the token to an additional master, especially an additional MC1,);
information concerning the points in time at which or the sequence in which devices are information technically connected or the information technical connection is interrupted; and/or
the association of a field device, which is information technically connected to the fieldbus, with a particular master (MC1, in the case of a Profibus® fieldbus).

The fieldbus interface can especially also provide a documentation concerning points in time or sequence, so that the history of such changes can be traced. This is especially advantageous as regards subsequent error analysis.

The individual steps of the method of the invention, as well as method steps of the further developments, so far such is technically sensible, are preferably automatically performed via correspondingly installed software and/or hardware of the fieldbus interface. The fieldbus is especially embodied according to the Profibus® standard (compare e.g. Profibus Profile Specification, Version 3.0) or according to the Foundation® Fieldbus standard (compare e.g. Foundation® Specification, Function Block Application Process, Revision FS 1.7).

As already explained above, also other information can be queried by the fieldbus interface in an active communication, as well as be registered by the fieldbus interface. In an advantageous further development, the step of need-dependent performing of active communication includes retrieving identification information for the driver and versions management of at least one device—especially a field device—information technically connected to the fieldbus. Furthermore, the step of registering includes the registering retrieved identification information for the driver and versions management. In this way, the fieldbus interface can provide further information to the individual devices, especially field devices.

The queried identification information for the driver and versions management of a field device especially comprises at least such information concerning the field device, which identifies the field device with respect to device type, manufacturer as well as hardware and software version, to the extent that it can be seen therefrom which information is to be used for device integration for the relevant field device. The queried identification information can, however, also include other identification information beyond this. In the case of a fieldbus according to the Profibus® standard, it can especially be provided that completely or partially queried by the fieldbus interface as identification information are I&M parameters (I&M: Identification & Maintenance functions), which are defined in the Profibus® standard (compare Profibus® Profile Guidelines, Part 1, Identification & Maintenance Functions, Version 1.1, May 2003). I&M parameters describe, in such case, device identifying parameters such as manufacturer code, serial number, order number, profile class, hardware and software version. The format of the parameters, as well as also the communication services for reading out this parameter, is identical for all Profibus® devices. Furthermore, such I&M-parameters facilitate the accessing of device-specific online device information, which is provided, for example, on a web page of the device manufacturer (Vendor Asset Management System).

Furthermore, based on the identification information for the driver and versions management, it can be checked whether information stored in the fieldbus interface and/or in a superordinated communication unit for device integration, such as, for example, a device description or a device driver, are suitable for the particular field device actually information technically connected. This is especially helpful after replacement of a device, in order to prevent compatibility problems.

For a servicing a field device, it must be made known to the servicing system (e.g. a superordinated unit or a servicing device) especially the operating program implemented thereon, the properties of this field device which are relevant with respect to a servicing. By “information for device integration” (“means for device integration”) of a field device are generally described the properties of the field device, which are relevant for a servicing of the same. Information for device integration comprises especially the input and output signals delivered by the relevant field device, information concerning the communication of the field device via a fieldbus, parameters provided in the field device, status and diagnostic information delivered by the field device, data and rules for procedures (e.g. configuring, calibrating) and/or information concerning user interfaces, etc. In order to be able to service different field devices, especially field devices from different manufacturers, via one and the same operating program, standards have been created regarding this information for device integration.

Information for device integration of a field device can be formed, for example, by a device description (DD) of the field device. The device description is, as a rule, created in text-based form (e.g. in the ASCII text format). For this, depending on the fieldbus system used, different device description languages are used, such as, for example, the Foundation Fieldbus Device Description Language, GSD/Profibus (GSD: General Station Description), etc. The information provided in the device description is, as a rule, interpreted or translated by an interpreter, and provided to the operating program, which forms a frame application for the device description. Such a frame application for the device description is formed, for example, by the operating program “Application Designer®” of Endress+Hauser. Furthermore, information for device integration of a field device can, for example, also be formed by a device driver of the field device, especially a “Device Type Manager” (DTM). A device driver, especially a “Device Type Manager”, is, in such case, device-specific software, which encapsulates data and functions of the field device and provides graphical servicing elements. For its execution, such a device driver requires a corresponding frame application; for example, a “Device Type Manager” requires an FDT frame application (FDT: Field Device Tool) for execution. An operating program, which forms such an FDT frame application, is, for example, “FieldCare®” of Endress+Hauser.

It can furthermore be provided that a superordinated communication unit, especially a PAM system, automatically accesses a database provided by a manufacturer (“Vendor Asset Management System”), in order to check whether the particular information used for device integration is correct for the registered identification information for the driver and versions management of the relevant field device. In given cases, if this is not correct, the superordinated communication unit, especially the PAM system, can then automatically download correct information for device integration from the database. In this way, it is automatically assured that the correct information for device integration is in each case used in the superordinated communication unit, or, in given cases, in the fieldbus interface.

In such vendor asset management systems, information concerning field devices is provided centrally in a database. The accessing thereof is most often enabled via corresponding portal pages with password protected logins. There exists, in such case, the opportunity (via an authorized person or also automatically, e.g. via a PAM system) for the plant operator to access the information provided by the manufacturer concerning the assets of the plant, and/or to update this information. Especially, over the entire life cycle of a field device, access can be made to current information concerning the field device, such as, for example, information concerning calibrating, maintenance and repair work, information to be used for device integration, concerning procurement, installation, system integration and operation, etc. Such a vendor asset management system is provided, for example, by Endress+Hauser via the “Web-Enabled Asset Management System W@M”.

The term “field device” refers not only to sensors and/or actuators. Rather, also units connected directly to the fieldbus and serving for communication with a superordinated unit (e.g. a PLC), such as, for example, remote I/Os, gateways, and linking devices, are referred to as field devices.

A retrieval of I&M-parameters is, in the case of a Profibus® network, only possible via an MC2 in an acyclic communication. In order to be able to effect such a retrieval and in order, alternatively or supplementally, also be able to retrieve other information (not obtainable in the context of process control, or in the context of cyclic communication), the fieldbus interface is, according to an advantageous further development, embodied as an MC2.

In an advantageous further development, the active communication of the fieldbus interface is in the form of an acyclic communication. In this way, especially in the case of a Profibus® fieldbus, a retrieval of more extensive information, such as is possible in a cyclic communication, is enabled. Furthermore, an acyclic communication can be performed according to need, so that when no information is required, the bus traffic is not unnecessarily burdened.

If the fieldbus is embodied according to the Profibus® standard, in normal operation, a superordinated unit, such as, for example, a PLC, which forms an MC1, performs process control in the context of the cyclic communication. In the case of such a cyclic communication, the superordinated unit (or the MC1) forms a master with respect to the field devices associated therewith, which form slaves. For example, in one cycle, via the superordinated unit, according to predetermined rules, measured values are input from the individual sensors of the fieldbus associated with the superordinated unit, and, as a function of the obtained measured values, control commands are output to the individual actuators associated therewith. If all field devices associated with the superordinated unit are serviced, the cycle is ended. After termination of a cycle, the superordinated unit passes the token to an MC2, to the extent that such is connected to the fieldbus. In the case of provision of a fieldbus interface of the invention, which forms an MC2, the token is thus forwarded to the fieldbus interface. During the period of time between two successive cycles, the fieldbus interface has the opportunity to communicate in an acyclic communication with individual field devices, especially to query for information from these.

If the fieldbus is embodied according to the Foundation®-Fieldbus standard, as a rule, in each fieldbus segment, one of the devices connected thereto is then embodied as an LAS (Link Active Scheduler). Such an LAS plans and controls the communication to the relevant fieldbus segment. In such case, the LAS performs, as a rule, also tasks of network management, such as, for example, performing a regular retrieval of the fieldbus addresses, in order to test which devices are information technically connected at the different fieldbus addresses. In the context of the cyclic communication, the LAS goes through the individual addresses of a fixed address range (devices are permanently information technically connected under these addresses) and gives the different function block's of the field devices, according to its schedule, the opportunity to perform a communication. After performing this cyclic communication, the LAS gives devices, which temporarily log in under an address of the temporary address range, the opportunity to perform an (acyclic) communication. Accordingly, when it would like to perform an acyclic communication, the fieldbus interface must log in under an address of the temporary address range. After the exchange of corresponding telegrams, in which the fieldbus interface has sufficiently identified itself to the LAS as regards its properties, the fieldbus interface receives the token from the LAS and has the opportunity to perform an acyclic communication.

In an advantageous further development, the step of registering includes registering additional monitored information by the fieldbus interface. In this way, the fieldbus interface can provide to a superordinated communication unit still further information. According to an advantageous further development, the additional monitored and registered information includes at least one of the following types of information:
diagnostic information from at least one field device information technically connected to the fieldbus, transmitted in a cyclic communication;
association of at least one field device information technically connected to the fieldbus with a master, obtainable from a cyclic communication, and/or
status information concerning the communication state of at least one field device information technically connected to the fieldbus, obtainable from a cyclic communication.

In the case of a fieldbus according to the Profibus® standard, diagnostic information of various types can be transmitted in a cyclic communication. In the context of the cyclic data exchange (DATA EXCHANGE) between the MC1 and a field device, the beginning of a diagnosis event is displayed, for example, by means of the field device sending back with high priority a response telegram (DATA_EXCH.res) for a query, or request, telegram (DATA_EXCH.req) of the MC1. Such a diagnostic event can be present, for example, when a field device is operated over a longer period of time at too high a temperature. Upon obtaining a telegram with high priority, the MC1 transmits to the field device a diagnostic query telegram (SLAVE_DIAG.req). In response thereto, the field device transmits diagnostic information in a diagnostic response telegram (SLAVE_DIAG.res). The cyclic data exchange is then continued. If the diagnostic event in the field device ends or a change in the diagnostic data occurs, the field device then sends a response telegram (DATA_EXCH.res) to a query telegram (DATA_EXCH.req) of the MC1 back with high priority. Then, the MC1 in turn queries the field device for diagnostic information via transmission of a diagnostic query telegram (SLAVE_DIAG.req).

The terminology “diagnostic information” also includes alarm reports. Furthermore, in the case of a fieldbus according to the Profibus® standard as well as also in the case of a fieldbus according to the Foundation® Fieldbus standard, a transmitted measured value is accompanied in each case by its respective status. The status is, in such case, formed by a base quality, a quality substatus and by information concerning the violation of limit values. The terminology “diagnostic information” also refers to this status.

The terminology “communication state” refers to the possible states of the Profibus® state machine. In order that a cyclic data exchange with a slave (field device) can take place, the latter must be in the communication state DATA EXCHANGE (short: DXCHG). In order to bring the slave into this communication state, after a turning-on (Power ON) or after a reset of the MC1, the slave of the MC1 must receive and answer a sequence of telegrams. In such case, especially the “status information concerning the communication state” gives in which communication state the relevant field device is sitting.

Via the fieldbus interface, the respective information preferably is registered not only as regards content, but also at least partially as regards points in time of the respective changes. In this way, by the fieldbus interface, or, in given cases, via a superordinated communication unit, such as, for example, a PAM system, the development in time of the changes (history) can documented and/or trends can be created.

In an advantageous further development, the step of need-dependent performing of an active communication includes retrieval by the fieldbus interface of diagnostic information of at least one field device information technically connected to the fieldbus, and the step of registering includes the registering of queried diagnostic information by the fieldbus interface. As is explained above, this retrieval can occur especially in an acyclic communication, so that more extensive diagnostic information than are obtainable in a cyclic communication can be queried for. Such further diagnostic information can concern, for example, degree of wear of a probe, accretion formation on a sensor, number of operating hours, etc.

In such case, further diagnostic information, which is queryable via a MC2, is already specified in the Profibus® standard for Profibus® PA devices. Additionally or alternatively to standardized diagnostic information, manufacturer-specific diagnostic information can also be provided in a field device, wherein this information is made known to the respective MC2 via the associated information for device integration of the field device.

In the present invention, active communication is performed by the fieldbus interface only as needed. Such a “need-dependent” performance can be initiated, in such case, by the fieldbus interface itself, by a superordinated communication unit (e.g. a PAM system), which is in communicative connection with the fieldbus interface, and/or by a user. This can, for example, occur as a function of the presence of particular conditions, such as, for example, that in the context of the process control, a particular piece of information (e.g. a telegram with high priority, a particular transmitted value, an alarm or error report, a diagnostic query, etc.) is transmitted via the fieldbus and/or can occur by a rule or an algorithm providing a schedule or flow diagram for performing particular active communications.

In an advantageous further development, the step of need dependent performing of active communication by the fieldbus interface is initiated as a function of monitored information, which is transmitted via the fieldbus in a cyclic communication. Additionally or alternatively, according to an advantageous further development, it is provided that the step of need-dependent performing of active communication by the fieldbus interface is initiated by a superordinated communication unit (e.g. a PAM system), which is in communicative connection with the fieldbus interface.

In an advantageous further development, based on registered information, which concerns the network management of the fieldbus, the fieldbus interface creates and updates a list of devices information technically connected to the fieldbus. Via such a list or table, which is also referred to as a “Live List”, information, which concerns the network management of the fieldbus, can be transmitted—summarized in a clearly organized manner, updated and, in given cases, collected—to a superordinated communication unit.

In an advantageous further development, the fieldbus interface compiles and updates in the list other registered information concerning devices information technically connected to the fieldbus. Thus, an expanded list or table is created, which is also referred to as an “Extended Live List”. Such additional registered information can especially be identification information of the field devices for driver and versions management, diagnostic information for the particular field devices, association of the field devices with a master and/or status information concerning the communication state, etc. As is explained above, it can furthermore be provided that in the list, not only is the particular current information registered, but also, at least for a part of the information, the sequence and/or points in time of the respective changes are registered and documented.

Furthermore, it can also be provided that the bus status of the fieldbus is monitored by the fieldbus interface. Additionally, the information registered for this purpose can also be evaluated and/or trends can be created. This evaluation and creation of trends for the bus status can be performed by the fieldbus interface itself or also partially or completely via a superordinated communication unit (e.g. a PAM system), which is in communicative connection with the fieldbus interface. the monitoring of the bus status of the fieldbus by the fieldbus interface can include registering changes in the signal quality on the fieldbus, as indicated, for example, by increase of telegram repeats, effects due to changing cable properties, which are caused, for example, by aging of insulation, and/or changes in the cable installation, etc.

In a further development, on its own initiative or by request from a superordinated communication unit (e.g. a PAM system), which is in communicative connection with the fieldbus interface, the fieldbus interface transmits information registered and in given cases further processed and/or stored in the fieldbus interface to the superordinated communication unit. In this way, the information can be made use of in a superordinated communication unit—such as, for example, a PAM system—without this superordinated communication unit needing to be connected to the fieldbus. In this way, information from a large number of fieldbus segments can be utilized in the superordinated communication unit.

Preferably, the registered information is already further processed and/or a number of pieces of information are summarized (or collected) in suitable manner in the fieldbus interface. The information can then be transmitted to the superordinated communication unit in this further processed and/or summarized form. In this way, the superordinated communication unit obtains higher value information and data traffic between the superordinated communication unit and the fieldbus interface can be reduced. For example, instead of a plurality of individual pieces of information, the above described list can be transmitted, or summarized diagnostic information concerning a plurality of field devices of the fieldbus segment can be transmitted.

The collected transmission can especially occur with the assistance of a CommDTM (communication DTM) of the fieldbus interface. Such a CommDTM is, in such case, implemented in the respective superordinated communication unit and is responsible for the communication services with the fieldbus interface. In such case, such a CommDTM can retrieve the above described list or other further processed and/or summarized information directly from a corresponding memory (especially from a buffer) of the fieldbus interface. For example, the CommDTM can already contain such a current list and provide it to a corresponding frame application of the superordinated communication unit, when required.

In a further development, at least in the case of
occurrence of a change in registered information,
exceeding at least one predetermined limit value and/or
a predetermined rule
   the fieldbus interface transmits information registered and, in given cases further processed and/or stored, in the fieldbus interface to the superordinated communication unit (e.g. a PAM system). In this way, depending on the situation (e.g. in the case of occurrence of a change and/or in the case of exceeding a limit value), the fieldbus interface can inform the superordinated communication unit of such. In this way, the superordinated communication unit is informed in an up-to-date manner about important events, without the traffic across the communication connection being unnecessarily increased thereby. In a predetermined rule, which preferably is stored in the fieldbus interface, it can, for example, be specified that the fieldbus interface transmits to the superordinated communication unit in predetermined time intervals (i.e. regularly) and/or situation dependently (e.g. in the case of occurrence of a change and/or in the case of exceeding a limit value).

In a further development, the fieldbus interface includes information for device integration for at least one field device information technically connected to the fieldbus, especially a device description and/or a device driver of such a field device. In this way, a further evaluation of the monitored information can be performed by the fieldbus interface. Accordingly, the fieldbus interface itself can, with targeting and taking into consideration the specific properties of the respective field device, generate queries, which are made to the particular field device in an active communication. Furthermore, the fieldbus interface can further process or condition monitored information and transmit this in such further processed form to the superordinated communication unit.

Alternatively or supplementally, information for device integration for at least one field device information technically connected to the fieldbus can also be provided in a superordinated communication unit, such as, for example, in a PAM system. In this way, the handling and, in given cases, the reloading of information for device integration is facilitated, since the superordinated communication unit can more easily be connected to a vendor asset management system. Furthermore, the provision of information for device integration exclusively in the superordinated communication unit can be sensible, if the fieldbus interface is not sufficiently equipped for such extensive storage and data processing. On the other hand, by the provision of information for device integration in the fieldbus interface, essential working steps can be performed in the fieldbus interface both with respect to the creation of queries as well as with respect to the evaluation of the monitored information, wherein these working steps would otherwise need be performed via the superordinated communication unit (e.g. via a PAM system). By this transfer of location, data traffic between the superordinated communication unit and the fieldbus interface can be reduced. Furthermore, the load on the superordinated communication unit is reduced thereby.

In an advantageous further development, the fieldbus interface, referencing the information for device integration of a field device, performs at least one of the following steps:
evaluating registered information concerning the field device,
placing (as well as creating) active queries to the field device, which especially also includes profile-specific or device-specific queries, and/or
initiating transmission of registered and in given cases further processed information to a superordinated communication unit, which is in communicative connection with the fieldbus interface.

In a further development, the method includes the following steps:
D) comparing registered identification information for the driver and versions management of at least one field device connected to the fieldbus with information for device integration currently used for such field device; and,
E) based on the comparison, determining whether the correct information for device integration is being used for the field device.

As concerns the advantages achievable thereby, reference is made to the explanations above. The steps of comparing and determining can be performed, in such case, especially by the fieldbus interface, to the extent that such has information for device integration. Additionally or alternatively, these steps can also be performed via a superordinated communication unit, which is in communicative connection with the fieldbus interface, such as, for example, a PAM system. In such case, the superordinated communication unit can especially check whether the information for device integration used by the unit itself or also by another, especially subordinated (with respect to the network structure) unit, such as, for example, the fieldbus interface, is correct. Furthermore, for performing these steps, as is explained above, also a vendor asset management system can be taken into consideration.

In a further development, the superordinated communication unit is formed by a plant asset management system, which is especially in communicative connection with the fieldbus interface via a superordinated network.

The present invention furthermore relates to a fieldbus interface for connection to a fieldbus of process automation technology, wherein the fieldbus interface is embodied in such a manner that during operation the data traffic on the fieldbus is monitored by the fieldbus interface, and parallel to this monitoring function, active communication is performable by the fieldbus interface, and monitored information, which concerns network management of the fieldbus, is registered by the fieldbus interface.

The fieldbus interface of the invention provides essentially the advantages explained above with reference to the method of the invention. Furthermore, also the further developments in each case explained with reference to the method of the invention are implementable in corresponding manner, wherein the respective method steps, insofar as such is technically sensible, are implementable via correspondingly installed software and/or hardware of the fieldbus interface.

Further advantages and utilities of the invention will now be explained in greater detail on the basis of the appended drawing, the figures of which show as follows:

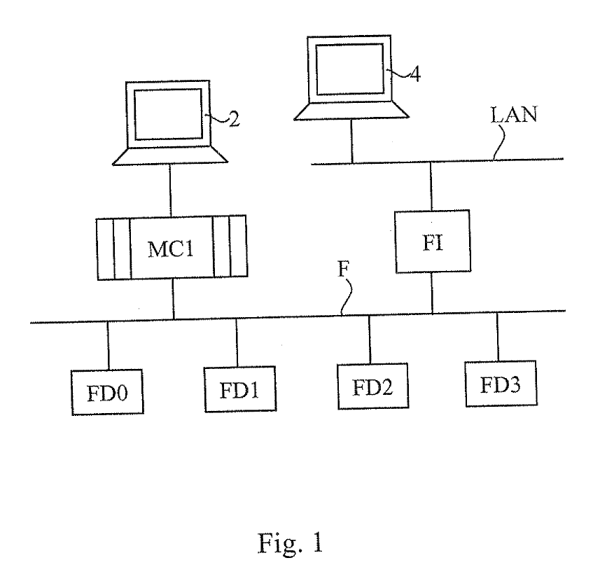

FIG. 1 a schematic representation of a fieldbus segment, which is connected via a fieldbus interface with a superordinated network, for explanation of a form of embodiment of the invention; and

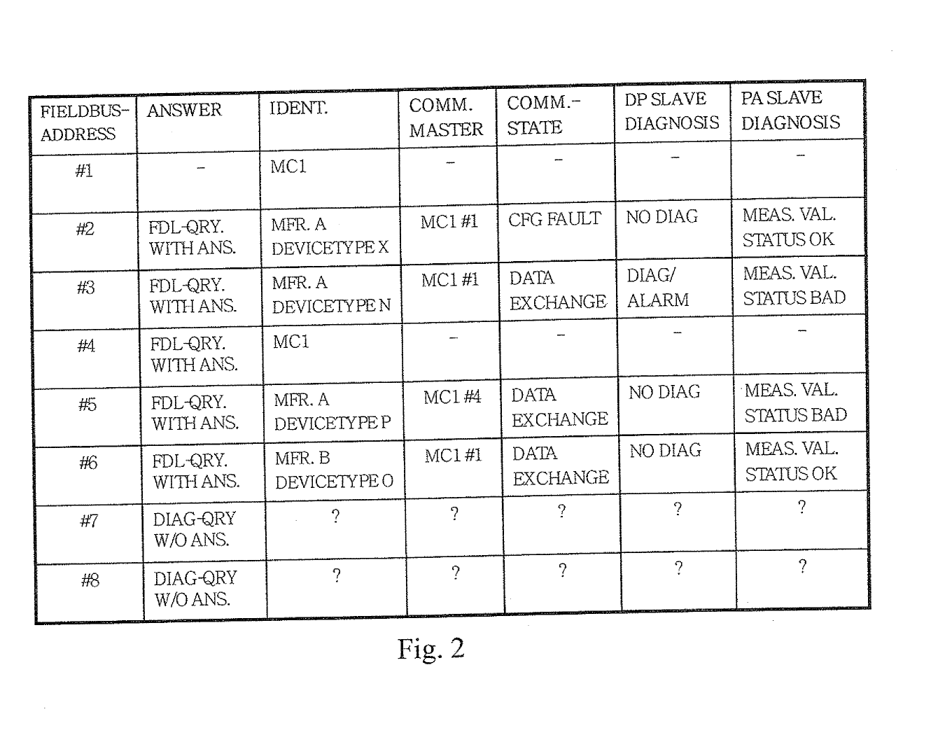

FIG. 2 by way of example, a representation of an expanded live list.

FIG. 1 shows schematically a fieldbus segment, in the case of which four field devices FD0, FD1, FD2 and FD3, as well as a superordinated unit MC1 are connected to a fieldbus F. The fieldbus F works according to the Profibus® standard. The superordinated unit MC1, which in the present example is formed by a PLC, is configured as a master class 1 (MC1), while each of the field devices FD0, FD1, FD2 and FD3 is a slave. Superordinated unit MC1 is connected with a computer 2, which serves as a visualizing system (for example, for display of process parameters, etc.). Communication between superordinated unit MC1 and field devices FD0, FD1, FD2 and FD3 occurs according to the Profibus® standard. In such case, the superordinated unit performs process control with respect to the field devices FD0, FD1, FD2 and FD3, as was, for example, already explained above in the Summary.

Furthermore connected to fieldbus F is a fieldbus interface FI, which provides a connection to a superordinated network LAN. The superordinated network LAN is, for example, a local company network, which is embodied as an Ethernet LAN. In such case, the superordinated network LAN can also be connected to the global Internet. Connected to the superordinated network LAN is a PAM system 4, which, with respect to the network structure and relative to the fieldbus interface FI, forms a superordinated communication unit.

Still other devices and/or networks can also be connected both to fieldbus F as well as also to the superordinated network LAN.

As already explained above in the Summary, during operation, the fieldbus interface FI continuously monitors the data traffic on the fieldbus F. When needed, it furthermore performs an active communication in parallel with the monitoring of the data traffic. Furthermore, it registers monitored information concerning network management of fieldbus F.

In such case, in the illustrated form of embodiment, one or more of the above explained further developments and/or variants can be implemented.

In the case of the illustrated form of embodiment, the fieldbus interface FI is especially configured as a master class 2 (MC2). The performing of an active communication by the fieldbus interface FI occurs in an acyclic communication. In such case, in the context of the acyclic communication by the fieldbus interface FI, especially identification information for the driver and versions management of the field devices FD0, FD1, FD2 and FD3 information technically connected to the fieldbus F is queried and at least partially registered. Moreover, as is explained above, also other information can be queried and/or other, monitored information can be registered by the fieldbus interface FI. The fieldbus interface FI furthermore performs protocol conversion between the protocol of the superordinated network LAN and the Profibus® protocol of fieldbus F.

Further implemented on the fieldbus interface FI is information for device integration for the different field devices FD0, FD1, FD2 and FD3 of fieldbus F. In such case, making use of the information for device integration, fieldbus interface FI further processes the registered information, and, with targeting as a function of the registered information, creates other queries, which it communicates in acyclic communication with the individual field devices FD0, FD1, FD2 and FD3. Based on registered information concerning network management of fieldbus F, as well as based on additional registered information, fieldbus interface FI especially creates and updates an expanded live list for the field devices FD0, FD1, FD2, FD3 information technically connected to fieldbus F. The fieldbus interface FI transmits the expanded live list to the PAM system 4 via the superordinated network LAN on request by PAM system 4, or when a change in the information registered in the live list occurs. Along with that, it can also be provided that the fieldbus interface FI also transmits other information to the PAM system 4. Such a transmission can occur not only in the case of occurrence of a change in the registered information, but also in the case of exceeding a predetermined limit value and/or according to a predetermined rule (or algorithm), which is stored in the fieldbus interface FI.

Also the queries, which are made in active communication by the fieldbus interface FI to one or more field devices FD0, FD1, FD2 and FD3 connected to the fieldbus F, are, among other things, created and placed as a function of monitored information, in given cases referencing information for device integration of the relevant field device. Furthermore, certain queries are also regularly created and placed according to a previously determined algorithm. Moreover, corresponding retrievals can also be initiated via PAM system 4, which sends a corresponding query to fieldbus interface FI.

At the fieldbus interface FI, it can especially be set by a user or by the PAM system 4 (or also by another superordinated communication unit) under which conditions a transmission of which information to the PAM system 4 (or also to another, superordinated communication unit) should occur. At the fieldbus interface FI, it can also be set by a user or by PAM system 4 (or also by another superordinated communication unit) under which conditions which queries can be created and sent by the fieldbus interface FI.

In the following, with reference to FIG. 2, an example of an expanded live list, which was created by a fieldbus interface formed according to the invention, will now be explained. The fieldbus in question is, in such case, formed again by a fieldbus according to the Profibus® standard, wherein the fieldbus is connected to the fieldbus interface of the invention, and wherein the process control is performed by two superordinated units, each of which is a master class 1 (MC1). The fieldbus interface forms, in turn, a master class 2 (MC2).

A first column of the illustrated table gives the different fieldbus addresses provided in the fieldbus, which in the present case are formed by the addresses #1, #2, #3, . . . , #8. The superordinated units, which perform the process control, are in the present case connected at the addresses #1 and #4.

In the context of its network management tasks, the superordinated unit MC1 at the address #1 regularly performs a retrieval of the fieldbus addresses, in order to test which devices are information technically connected at the different fieldbus addresses. The corresponding retrievals are referred to in the table with “FDL-QRY.” (FDL: Fieldbus Data Link). The second column bearing the heading “ANSWER” shows at which fieldbus addresses there are devices that respond to the corresponding query (given in the second column by “FDL-QRY. WITH ANS.”) and thus are information technically connected. The fieldbus interface can register the information set forth in the second column exclusively by monitoring the data traffic on the fieldbus.

As is evident based on the second column of the table, devices are information technically connected are at the addresses #2, #3, #4, #5 and #6. At the addresses #7 and #8, devices were in each case formerly information technically connected. Now, however, no response to a query is obtained. Thereupon, the MC1 of the address #1 (in the following “MC1 #1”) sent a diagnostic query (given in the table as “DIAG-QRY.”) to the two addresses #7 and #8. Also to these diagnostic queries, the MC1 #1 in each case obtained no response, which is given in the table by “DIAG-QRY. W/O ANS.”, wherein W/O stands for ‘without’. The reason for this can be, for example, that serious defects occurred in the relevant devices, especially in the area of their mechanical connections, or that the devices were removed by a user.

In the context of an active communication, the fieldbus interface also queries for identification information for the drivers and versions management of the individual devices information technically connected at the different fieldbus addresses. The third column of the table gives for the field devices, as examples of such identification information, manufacturer (MFR.) and device type (DEV_TYPE). In the case of the master classes 1, only this property, namely “MC1”, is given. Alternatively or supplementally, still other identification information for the driver and versions management, especially other I&M parameters, can also be queried by the fieldbus interface and registered in the table. For the addresses #7 and #8, in each case, no information is present, which is indicated in the table by a “?”. This is the case also for the subsequent columns of the table.

In the fourth column under the heading “COMM. MASTER”, the association of the individual field devices with a particular MC1 is given. As is evident from the table, the field devices with the addresses #2, #3 and #6 are associated with MC1 #1, while the field device with address #5 is associated with MC1 #4 (MC1 of address #4). In the fifth column with the heading “COMM. STATE”, the respective communication states of the individual field devices are given. As can be seen from the data for the individual field devices, the field devices with the addresses #3, #5 and #6 are in each case in the communication state “DATA EXCHANGE”. Accordingly, the respective MC1 performs a normal process control with these field devices. Solely the field device with the address #2 could not go into the state DATA EXCHANGE″, since during the communication state of the configuration, an error has occurred. This is given in the fifth column by the statement “CFG FAULT” (Configuration Fault). The fieldbus interface can register the information set forth in the fourth and fifth columns exclusively by monitoring the data traffic on the fieldbus.

The sixth and seventh columns of the table give diagnostic information for the field devices information technically connected to the fieldbus (i.e. the field devices at the addresses #2, #3, #5 and #6). In the sixth column with the heading “DP SLAVE DIAGNOSIS”, diagnostic information is contained, which is standardized at least for a DP slave. Based on this diagnostic information, it can especially be detected whether a diagnostic event has occurred in the relevant field device. In particular, in the field devices at the addresses #2, #5 and #6, no diagnostic event has occurred. As is explained above in the Summary, in the context of the cyclic data exchange with the respective MC1, these field devices in each case transmit telegrams with low priority, so that the respective MC1 is not induced to transmit a diagnostic query telegram (SLAVE_DIAG.req). This is in each case given in the sixth column by “NO DIAG”. In the case of the field device of address #3, in contrast, a diagnostic event has occurred, which has the result that, in the context of the cyclic data exchange, this field device sent back a response telegram with high priority to the associated MC1.

In this way, the MC1 (here: MC1 #1) was caused to transmit a diagnostic query telegram (SLAVE_DIAG.req) to the field device at address #3. In the associated diagnostic response telegram (SLAVE_DIAG.res), the field device at address #3 transmitted an alarm message to MC1 #1. This is given in the sixth column by “DIAG/ALARM”. The fieldbus interface can register the information set forth in the sixth column exclusively by monitoring the data traffic on the fieldbus.

From the seventh column with the heading “PA SLAVE DIAGNOSIS” can be seen that for a PA slave, further standardized diagnostic information is obtainable by the fieldbus interface. In the case of the illustrated form of embodiment, the fieldbus interface monitors the base quality of the status of the transmitted measured value (MEAS. VAL.) of the individual field devices. As is evident from the seventh column, this is in order in the case of the field devices at addresses #2 and #6, such being indicated by “OK”. In the case of the field devices at addresses #3 and #5, the base quality is poor, which is indicated by “BAD”. Here, the fieldbus interface is embodied in such a manner that, in the case of a poor base quality, it queries in an active (acyclic) communication targetedly for further diagnostic information. The further diagnostic information can be, especially, diagnostic information standardized for PA slaves. Alternatively or supplementally, however, it can also be additional, manufacturer-specific diagnostic information determined for the field device in question. For retrieval of such manufacturer-specific diagnostic information, the fieldbus interface requires device-specific knowledge, which it can obtain, for example, by the fieldbus interface having information for device integration.

1-15. (canceled)

16. A method for operating a fieldbus interface), which is connected to a fieldbus of process automation technology, comprising the steps of:
continuous monitoring of data traffic on the fieldbus by the fieldbus interface;
need-dependent performing of active communication by the fieldbus interface in parallel with the monitoring of the data traffic; and
registering by the fieldbus interface of monitored information concerning network management of the fieldbus.

17. The method according to claim 16, wherein:
said step of need-dependent performing of active communication includes retrieving identification information for driver and versions management of at least one device information technically connected to the fieldbus; and
said step of registering includes registering retrieved identification information for the driver and versions management.

18. The method according to claim 16, wherein:
said active communication of the fieldbus interface is formed by an acyclic communication.

19. The method as claimed in claim 16, wherein:
said step of registering includes the registering of additional monitored information by the fieldbus interface; and
this additional monitored and registered information includes at least one of the following types of information:
diagnostic information from at least one field device information technically connected to the fieldbus, transmitted in a cyclic communication;
association of at least one field device information technically connected to the fieldbus with a master, obtainable from a cyclic communication, and/or
status information concerning the communication state of at least one field device information technically connected to the fieldbus, obtainable from a cyclic communication.

20. The method as claimed in claim 16, wherein:
said step of need-dependent performing of active communication includes retrieval by the fieldbus interface of diagnostic information of at least one field device information technically connected to the fieldbus; and
said step of registering includes registering queried diagnostic information by the fieldbus interface.

21. The method as claimed in claim 16, wherein:
said step of need-dependent performing of active communication is initiated by the fieldbus interface as a function of monitored information, which are transmitted in a cyclic communication via the fieldbus, and/or
by a superordinated communication unit, which is in communicative connection with the fieldbus interface.

22. The method as claimed in claim 16, wherein:
based on registered information, which concern the network management of the fieldbus, the fieldbus interface creates and updates a list of device information technically connected to the fieldbus.

23. The method as claimed in claim 22, wherein:
the fieldbus interface compiles and updates in the list other registered information concerning device information technically connected to the fieldbus.

24. The method as claimed in claim 16, wherein:
on its own initiative or by request from a superordinated communication unit, which is in communicative connection with the fieldbus interface, the fieldbus interface transmits information registered and in given cases further processed and/or stored in the fieldbus interface to the superordinated communication unit.

25. The method as claimed in claim 24, wherein:
for at least the case of:
occurrence of a change in registered information,
exceeding at least one predetermined limit value and/or
a predetermined rule,
the fieldbus interface transmits information registered and, in given cases, further processed and/or stored, in the fieldbus interface, to the superordinated communication unit.

26. The method as claimed in claim 16, wherein:
the fieldbus interface includes information for device integration for at least one field device information technically connected to the fieldbus, especially a device description and/or a device driver of such a field device.

27. The method as claimed in claim 16, wherein:
the fieldbus interface, referencing the information for device integration of a field device;
evaluates registered information concerning the field device,
places active queries to the field device, which especially also include profile-specific or device-specific queries, and/or
initiates transmission of registered and in given cases further processed information to a superordinated communication unit, which is in communicative connection with the fieldbus interface.

28. The method as claimed in claim 17, further comprising the steps of:
comparing registered identification information for the driver and versions management of at least one field device connected to the fieldbus with information for device integration currently used for such field device; and,
based on the comparison, determining whether the correct information for device integration is used for such field device.

29. The method as claimed in claim 21, wherein:
the superordinated communication unit is formed by a plant asset management system, which is especially in communicative connection with the fieldbus interface via a superordinated network.

30. A fieldbus interface for connection to a fieldbus of process automation technology, wherein:
the fieldbus interface is embodied in such a manner that, during operation, data traffic on the fieldbus is monitored by the fieldbus interface, and parallel to this monitoring function, active communication is performable by the fieldbus interface; and
monitored information, which concerns the network management of the fieldbus, is registered by the fieldbus interface.
